(19) United States
(12) Patent Application Publication
(10) Pub. No.: US 2026/0170165 A1
(43) Pub. Date: Jun. 18, 2026

(54) SHEET DATA PROCESSING METHOD AND APPARATUS, DEVICE, MEDIUM, AND PRODUCT

(71) Applicant: Beijing Zitiao Network Technology Co., Ltd., Beijing (CN)

(72) Inventors: Shuying LI, Beijing (CN); Lu CHEN, Beijing (CN); Zhengwen WANG, Beijing (CN)

(21) Appl. No.: 19/415,515

(22) Filed: Dec. 10, 2025

(30) Foreign Application Priority Data
Dec. 16, 2024 (CN) 202411855282.3

(51) Int. Cl. G06F 21/62

(52) U.S. Cl. CPC G06F 21/6227

(57) ABSTRACT

Provided are a sheet data processing method and apparatus, a device, a medium and a product. The method includes: for a second terminal of a data sheet, when permission information is preconfigured for the data sheet and the permission information is used to indicate an access permission of each first terminal for data in the data sheet, if the second terminal detects that the permission information is in an effective state, the second terminal displays not only a dashboard used to describe a data analysis result for the data sheet, but also a switch component, so that a manager may use the switch component to flexibly configure whether the permission information is used to constrain the dashboard displayed by each first terminal.

### CROSS REFERENCE TO RELATED APPLICATIONS

This application is based on and claims priority of CN application with application No. 202411855282.3 filed on Dec. 16, 2024, the entire disclosure of which is hereby incorporated by reference.

### TECHNICAL FIELD

The present application relates to the technical field of the Internet, and in particular, to a sheet data processing method and apparatus, a device, a medium, and a product.

### BACKGROUND

For some scenarios, such as a data analysis result display scenario, these scenarios have the following needs: displaying a data analysis result for a data sheet by using a dashboard, so that each viewer may view the data analysis result through the dashboard. The dashboard includes a plurality of components, and any component is configured to display a result obtained by performing a specific analysis on the data sheet, for example, a result such as a leader board or a histogram.

### SUMMARY

To solve the above technical problems, the present application provides a sheet data processing method and apparatus, a device, a medium, and a product, which are favorable for improving user experience.

To achieve the above objective, the present application provides the following technical solutions.

The present application provides a sheet data processing method. The method includes: displaying a dashboard, where the dashboard is configured to describe a data analysis result for a data sheet, the data sheet is preconfigured with permission information, and the permission information is used to indicate an access permission of a first terminal for data in the data sheet; in response to the permission information being in an effective state, displaying a switch component, where the switch component is used to use the permission information to constrain the dashboard displayed in the first terminal; and in response to the switch component being in an on state, displaying first prompt information, where the first prompt information is used to indicate that the permission information is used to constrain the dashboard displayed in the first terminal.

In a possible implementation, the method further includes: in response to the switch component being in an off state, displaying second prompt information, where the second prompt information is used to indicate that the permission information is not used to constrain the dashboard displayed in the first terminal.

In a possible implementation, a display process of the switch component includes: in response to the permission information being in the effective state, adding to display the switch component on the dashboard.

In a possible implementation, an entry identification of a management page is displayed on the dashboard, and a display process of the switch component includes: in response to a trigger operation for the entry identification, displaying the management page, and in response to the permission information being in the effective state, adding to display the switch component on the management page.

In a possible implementation, after the adding to display the switch component on the dashboard, the method further includes: in response to switching the permission information from the effective state to an invalid state, canceling displaying the switch component on the dashboard.

In a possible implementation, after the adding to display the switch component on the management page, the method further includes: in response to switching the permission information from the effective state to an invalid state, canceling displaying the switch component on the management page.

In a possible implementation, after the displaying the switch component, the method further includes: in response to switching the permission information from the effective state to an invalid state, saving a state of the switch component and canceling displaying the switch component; and in response to switching the permission information from the invalid state to the effective state, displaying the switch component according to the saved state.

In a possible implementation, the method further includes: if a state switch request triggered for the switch component and a first request for requesting to switch the permission information from the effective state to an invalid state are detected simultaneously, executing the first request and displaying third prompt information, where the third prompt information is used to indicate that execution of the state switch request fails because the permission information is in the invalid state, and the state switch request is used to request to switch the switch component from an off state to an on state, or to switch the switch component from an on state to an off state.

In a possible implementation, the method is applied to a second terminal, and the method further includes: if a state switch request triggered for the switch component and a second request for requesting to cancel a management permission of the second terminal for the data sheet are detected simultaneously, executing the second request and displaying fourth prompt information, where the fourth prompt information is used to indicate that execution of the state switch request fails because the second terminal does not have the management permission for the data sheet, and the state switch request is used to request to switch the switch component from an off state to an on state, or to switch the switch component from an on state to an off state.

In a possible implementation, different requests are triggered by different terminals, and the state switch request is triggered by the second terminal.

In a possible implementation, the data sheet is preconfigured with a plurality of first terminals, and the method further includes: in response to a preview operation triggered for the dashboard, displaying a preview page, where the preview page displays, by default, a display effect of the dashboard on a third terminal, and the plurality of first terminals include the third terminal; and in response to a preview object switch operation triggered for the preview page, updating the preview page, where the preview object switch operation is used to indicate switching from the third terminal to a fourth terminal, the plurality of first terminals include the fourth terminal, and the updated preview page is used to display a display effect of the dashboard on the fourth terminal.

The present application provides a sheet data processing method. The method is applied to a first terminal, and the method includes: displaying a dashboard, where the dashboard is determined according to a data sheet, the data sheet is preconfigured with permission information, and the permission information is used to indicate an access permission of the first terminal for data in the data sheet; in response to a state switch operation triggered for a switch component on a second terminal, displaying a prompt page, where the prompt page is used to indicate that a data permission of the dashboard has changed; and in response to a trigger operation for an update component in the prompt page, updating the dashboard, where the dashboard before the updating is not constrained by using the permission information, the state switch operation is used to indicate switching the switch component from an off state to an on state, and the updated dashboard is constrained by using the permission information, or the dashboard before the updating is constrained by using the permission information, the state switch operation is used to indicate switching the switch component from an on state to an off state, and the updated dashboard is not constrained by using the permission information.

In a possible implementation, the dashboard includes a plurality of components, and different components are used to display different data analysis results for the data sheet; and when the dashboard is constrained by using the permission information, if the permission information indicates that the first terminal has no permission to access a first data set in the data sheet, and the first data set includes any column or any row in the data sheet, for any component in the dashboard, a display process of the component includes: if key information for rendering the component includes the first data set, using preset content to replace the component for display, where the key information is used to form the data analysis result displayed by the component, and the preset content is used to indicate that the first terminal has no permission to view the data analysis result displayed by the component; and if the key information for rendering the component does not include the first data set, rendering the component according to the data sheet and displaying the component.

In a possible implementation, the dashboard includes a plurality of components, and different components are used to display different data analysis results for the data sheet; and when the dashboard is constrained by using the permission information, if the permission information indicates that the first terminal has no permission to access some data in a second data set in the data sheet, and the second data set includes any column or any row in the data sheet, for any component in the dashboard, a display process of the component includes: if key information for rendering the component includes the second data set, rendering the component according to data other than the some data in the second data set and displaying the component, where the key information is used to form the data analysis result displayed by the component; and if the key information for rendering the component does not include the second data set, but a rendering process of the component uses the second data set, rendering the component according to data other than the some data in the second data set and displaying the component.

The present application provides a sheet data processing apparatus. The apparatus includes: a first display unit, configured to display a dashboard, where the dashboard is configured to describe a data analysis result for a data sheet, the data sheet is preconfigured with permission information, and the permission information is used to indicate an access permission of a first terminal for data in the data sheet; a second display unit, configured to display a switch component in response to the permission information being in an effective state, where the switch component is used to configure whether the permission information is used to constrain the dashboard displayed by the first terminal; and a third display unit, configured to display first prompt information in response to switching the switch component from an off state to an on state, where the first prompt information is used to indicate that the permission information is used to constrain the dashboard displayed by the first terminal, or display second prompt information in response to switching the switch component from an on state to an off state, where the second prompt information is used to indicate that the permission information is not used to constrain the dashboard displayed by the first terminal.

The present application provides a sheet data processing apparatus. The apparatus includes: a fourth display unit, configured to display a dashboard, where the dashboard is determined according to a data sheet, the data sheet is preconfigured with permission information, and the permission information is used to indicate an access permission of a first terminal for data in the data sheet; a fifth display unit, configured to display a prompt page in response to a state switch operation triggered for a switch component on a second terminal, where the prompt page is used to indicate that a data permission of the dashboard has changed; and an update unit, configured to update the dashboard in response to a trigger operation for an update component in the prompt page, where the dashboard before the updating is not constrained by using the permission information, the state switch operation is used to indicate switching the switch component from an off state to an on state, and the updated dashboard is constrained by using the permission information, or the dashboard before the updating is constrained by using the permission information, the state switch operation is used to indicate switching the switch component from an on state to an off state, and the updated dashboard is not constrained by using the permission information.

The present application provides an electronic device. The device includes a processor and a memory. The memory is configured to store an instruction or a computer program. The processor is configured to execute the instruction or the computer program in the memory, to enable the electronic device to perform the sheet data processing method provided in the present application.

The present application provides a computer-readable medium having an instruction or a computer program stored thereon, where the instruction or the computer program, when executed by a device, enables the device to perform the sheet data processing method provided in the present application.

The present application provides a computer program product including a computer program carried on a non-transitory computer-readable medium, where the computer program includes program code for performing the sheet data processing method provided in the present application.

### BRIEF DESCRIPTION OF THE DRAWINGS

To describe the technical solutions in the embodiments of the present application or in the related art more clearly, the following briefly describes the drawings required for describing the embodiments or the related art. Apparently, the drawings in the following description show merely some embodiments of the present application, and a person of ordinary skill in the art may still derive other drawings from these drawings without creative efforts.

FIG. 1 is a flowchart of a sheet data processing method applied to a second terminal according to an embodiment of the present application;

FIG. 2 is a schematic diagram of a display process of a switch component according to an embodiment of the present application;

FIG. 3 is a schematic diagram of a state switch process of a switch component according to an embodiment of the present application;

FIG. 4 is a schematic diagram of a preview page according to an embodiment of the present application;

FIG. 5 is a flowchart of a sheet data processing method applied to a first terminal according to an embodiment of the present application;

FIG. 6 is a schematic diagram of a structure of a sheet data processing apparatus according to an embodiment of the present application;

FIG. 7 is a schematic diagram of a structure of a sheet data processing apparatus according to an embodiment of the present application; and

FIG. 8 is a schematic diagram of a structure of an electronic device according to an embodiment of the present application.

### DETAILED DESCRIPTION OF EMBODIMENTS

Research has found that in some dashboard implementation solutions, a dashboard is used, by default, to only statistics data that a viewer has permission to access, so that the solution has the following defects: because the solution supports only statistics of data that a viewer has permission to access, and does not support statistics of all data, the solution may satisfy only a requirement of a single scenario (such as a scenario in which a role attribute is considered), but cannot satisfy requirements of other scenarios (such as a general disclosure scenario), affecting user experience.

Research has further found that to overcome the defects shown in the preceding paragraph, whether data used for statistical analysis of each component in a dashboard is all data or data that a viewer has permission to access may be manually configured.

Research has further found that the solution shown in the preceding paragraph has the following defects: \textcircled{1} Configuration costs are relatively high, affecting user experience. \textcircled{2} Because a dashboard as a whole corresponds to a specific scenario, when a scenario switches, whether data used for statistical analysis of all components in the dashboard is all data or data that a viewer has permission to access needs to be manually reconfigured, resulting in relatively high scenario switching costs and affecting user experience.

Based on the above research, to better improve user experience, the present application provides a sheet data processing method. The method includes: for a second terminal of a data sheet, when permission information is preconfigured for the data sheet, and the permission information is used to indicate an access permission of each first terminal for data in the data sheet, if the second terminal detects that the permission information is in an effective state, the second terminal displays not only a dashboard configured to describe a data analysis result for the data sheet, but also a switch component, so that a manager may use the switch component to flexibly configure whether the permission information is used to constrain the dashboard displayed by each first terminal. In this way, it may be implemented, from a dashboard dimension, to flexibly configure whether data used for statistics of the dashboard is all the data in the data sheet or data that a viewer has permission to access, so that content displayed in the dashboard may be efficiently and flexibly adjusted based on requirements of different scenarios (such as a general disclosure scenario or a scenario in which a role attribute is considered), thereby effectively overcoming the defects shown in the preceding paragraph and effectively improving user experience.

Compared with the related art, the present application has at least the following advantages.

According to the technical solution provided in the present application, for a second terminal configured to manage a data sheet, when permission information is preconfigured for the data sheet, and the permission information is used to indicate an access permission of each first terminal for data in the data sheet, if the second terminal detects that the permission information is in an effective state, the second terminal displays not only a dashboard configured to describe a data analysis result for the data sheet, but also a switch component, so that a manager may use the switch component to flexibly configure whether the permission information is used to constrain the dashboard displayed by each first terminal. In this way, it may be implemented, from a dashboard dimension, to flexibly configure whether data used for statistics of the dashboard is all the data in the data sheet or data that a viewer has permission to access, so that content displayed in the dashboard may be efficiently and flexibly adjusted based on requirements of different scenarios (such as a general disclosure scenario or a scenario in which a role attribute is considered), thereby effectively improving user experience.

In addition, the present application does not limit an execution body of the sheet data processing method provided in the present application. For example, the method may be applied to a terminal device. For another example, the method may alternatively be implemented by a sheet data processing process between a terminal device and a server. The terminal device may be a smartphone, a computer, a personal digital assistant (PDA), a tablet computer, or the like. The server may be an independent server, a cluster server, or a cloud server.

To enable persons skilled in the art to better understand the solutions of the present application, the following clearly and completely describes the technical solutions in the embodiments of the present application with reference to the drawings in the embodiments of the present application. Apparently, the described embodiments are some but not all of the embodiments of the present application. All other embodiments obtained by a person of ordinary skill in the art based on the embodiments of the present application without creative efforts shall fall within the protection scope of the present application.

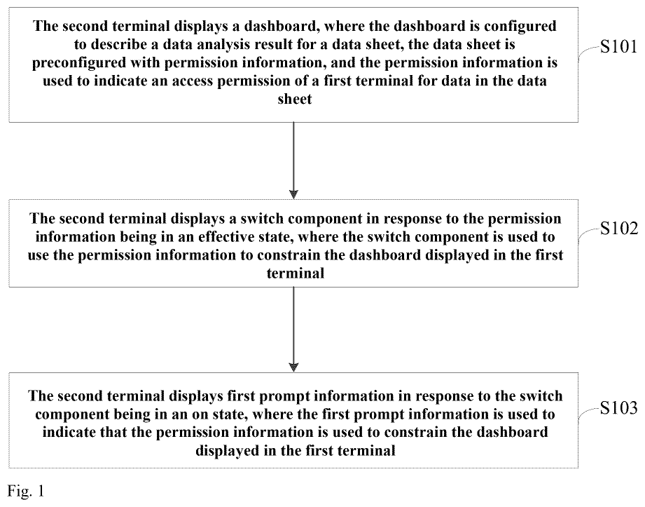

To better understand the technical solution provided in the present application, the technical solution is described below with reference to some drawings. As shown in FIG. 1, an embodiment of the present application provides a sheet data processing method applied to a second terminal, including the following S101 to S103.

S101: The second terminal displays a dashboard, where the dashboard is configured to describe a data analysis result for a data sheet, the data sheet is preconfigured with permission information, and the permission information is used to indicate an access permission of a first terminal for data in the data sheet.

The second terminal (also referred to as a management terminal) refers to a terminal that has a management permission for a data sheet (a data sheet shown in the following Table 1), so that a manager may use the terminal to implement some management items for the data sheet. In addition, the present application does not limit the second terminal. For example, the second terminal may be implemented by a terminal used to create the data sheet or a terminal that is granted the management permission.

TABLE 1
Data sheet

| sales date | sales amount | salesperson | region | profit |
|---|---|---|---|---|
| 2024 Nov. 1 | 170 | user 1 | region 1 | 100 |
| 2024 Nov. 2 | 228 | user 2 | region 1 | 203 |
| 2024 Nov. 3 | 212 | user 3 | region 1 | 109 |
| 2024 Nov. 4 | 848 | user 4 | region 1 | 500 |
| 2024 Nov. 5 | 219 | user 5 | region 1 | 100 |
| 2024 Nov. 6 | 583 | user 6 | region 2 | 300 |
| 2024 Nov. 7 | 282 | user 7 | region 2 | 123 |
| 2024 Nov. 8 | 4954 | user 8 | region 3 | 2555 |
| 2024 Nov. 9 | 322 | user 9 | region 3 | 299 |
| 2024 Nov. 10 | 2822 | user 10 | region 3 | 1999 |

A dashboard is obtained by performing statistical analysis on at least one data sheet, so that the dashboard may represent a data analysis result for the at least one data sheet. It should be noted that for any dashboard, the dashboard may be used to describe a data analysis result for a specific data sheet, or may be used to describe a data analysis result for some data sheets, which is not specifically limited in the present application.

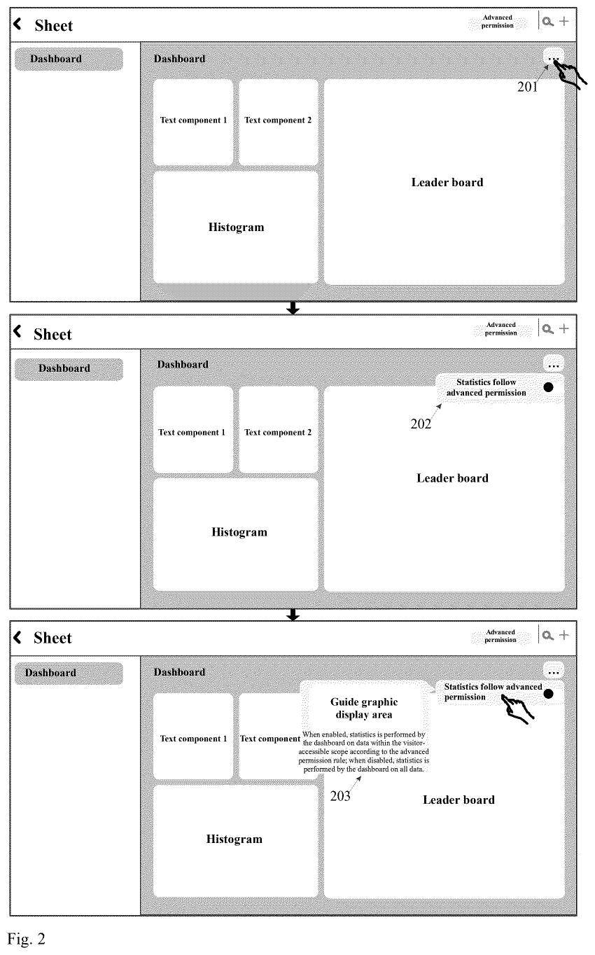

In addition, the dashboard may include a plurality of components (a text component 1, a text component 2, a histogram, and a leader board shown in FIG. 2), and different components are used to display different data analysis results (such as a sum, an average value, and a sorting result according to an indicator) for the data sheet, so that the dashboard may display a plurality of data analysis results for the data sheet.

In addition, the present application does not limit an implementation of a component in the dashboard. For example, the component may be a coordinate axis component (such as a histogram, a line chart, a bar chart, an area chart, a scatter chart, a combination chart, or a radar chart), a pie chart, a ring chart, a funnel chart, a word cloud, an indicator card, a leader board, a net promoter score (NPS) chart, a view component (such as a gantt chart, a kanban, or an album, which is a component used to directly display some data in the data sheet), a text component, or a button component.

In addition, to improve data security, permission information (for example, so-and-so has no permission to access the “region” column in Table 1) may be preconfigured for the data sheet, so that the permission information may describe an access permission of each first terminal for the data in the data sheet, so that data that may be viewed by each first terminal may be constrained subsequently based on the permission information. The first terminal (also referred to as an access terminal) refers to a terminal that is granted permission to access the data sheet, so that the first terminal may view, from the data sheet, data that it has permission to access, and view a dashboard generated based on the data sheet.

It should be noted that the present application does not limit the first terminal. For example, in some scenarios, a plurality of first terminals may be configured for the data sheet in advance, so that each first terminal has permission to view the data sheet, and the permission information configured for the data sheet is used to indicate an access permission of each first terminal for the data in the data sheet. In addition, the present application does not limit an implementation of the plurality of first terminals. For example, in some scenarios, the plurality of first terminals may include at least one terminal (referred to as a non-second terminal, also referred to as a normal terminal) that has only view permission for the data sheet. For another example, in some other scenarios, the plurality of first terminals may further include at least one terminal (referred to as a second terminal) that has a management permission for the data sheet.

In addition, to better improve flexibility, after the permission information is preconfigured for the data sheet, whether the permission information is used to constrain access permissions of different first terminals may be flexibly set based on some operations of the second terminal, so that data access requirements in different scenarios may be better satisfied. It should be noted that the present application does not limit the foregoing operations. For example, the operations may be implemented by using an enable operation or a disable operation triggered for the advanced permission shown in FIG. 2, so that subsequently, the permission information may be set, by triggering the enable operation for the advanced permission, to constrain the access permissions of the different first terminals, so that the permission information is in an effective state, and the permission information may be set, by triggering the disable operation for the advanced permission, not to constrain the access permissions of the different first terminals, so that the permission information is in an invalid state. In this way, whether the permission information is effective may be flexibly controlled.

S102: The second terminal displays a switch component in response to the permission information being in an effective state, where the switch component is used to use the permission information to constrain the dashboard displayed in the first terminal.

In the present application, for a dashboard obtained by performing statistical analysis on a data sheet, if it is detected that a terminal (such as the second terminal) used to display the dashboard has a management permission for the data sheet, and the permission information preconfigured for the data sheet is in an effective state, it may be determined that a user of the terminal may have a management requirement of “configuring the dashboard to be used to perform statistics on all data, or configuring the dashboard to be used to perform statistics on data that a viewer has permission to view”. Therefore, to better satisfy the requirement, a switch component (a switch entry “statistics follow advanced permission” shown in FIG. 2) may be displayed by using the dashboard, so that the user may use the switch component to flexibly select whether the dashboard performs statistical analysis based on the permission information.

It may be learned that a display condition of the switch component is that a terminal (such as the second terminal) configured to display the dashboard rendered based on the data sheet has the management permission for the data sheet, and the permission information preconfigured for the data sheet is in an effective state (for example, the advanced permission is enabled for the data sheet). The switch component is used to configure whether the permission information is used to constrain the dashboard displayed by the first terminal. In addition, the present application does not limit an implementation of the switch component. For example, the switch component may be implemented by using any component (the switch entry “statistics follow advanced permission” shown in FIG. 2) that may be flexibly switched between an on state and an off state.

In addition, the present application does not limit a display manner of the switch component. For example, the switch component may be directly displayed on the dashboard as an operable component, so that the user may directly use the switch component to flexibly and efficiently set a statistics manner of the dashboard without leaving the dashboard. It may be learned that in a possible implementation, the foregoing S102 may be specifically: the second terminal adds to display the switch component on the dashboard in response to the permission information being in the effective state, which is favorable for simplifying management operations.

For another example, to better save space, the switch component may be displayed on a secondary page (the management page 202 shown in FIG. 2) of the dashboard as an operable component, to relieve space pressure of the dashboard. It may be learned that in a possible implementation, when an entry identification (the entry identification 201 shown in FIG. 2) of the management page is displayed on the dashboard, the foregoing S102 may be specifically: the second terminal displays the management page (the page 202 shown in FIG. 2) in response to a trigger operation (such as a click operation) for the entry identification, and adds to display the switch component (the switch entry “statistics follow advanced permission” shown in FIG. 2) on the management page in response to the permission information being in the effective state. In this way, a new component may be added without increasing the space pressure of the dashboard, which is favorable for improving a display effect of the dashboard. The entry identification is used to uniquely identify an entry of the management page, and the management page is used to display some components, such as the switch component, that may assist in managing the dashboard.

In addition, the present application does not limit a default state of the switch component. For example, in some scenarios, such as a scenario in which data security is emphasized, the switch component is in the on state by default, and the dashboard is used, by default, to perform statistics on data that the viewer has permission to view, which is favorable for better improving data security. For another example, in some scenarios, such as a scenario in which user experience of an existing user is emphasized, the switch component is in the off state by default, and the dashboard is used, by default, to perform statistics on all data, so that a statistics manner used when the user previously used the dashboard may be continued, thereby avoiding interference with the user.

In addition, to better improve user experience, the switch component satisfies at least the following constraint: when a control cursor on the second terminal moves above the switch component, a function introduction page (the page 203 shown in FIG. 2) of the switch component is displayed, so that the user may better understand a function of the switch component by using the page.

S103: The second terminal displays first prompt information in response to the switch component being in an on state, where the first prompt information is used to indicate that the permission information is used to constrain the dashboard displayed in the first terminal.

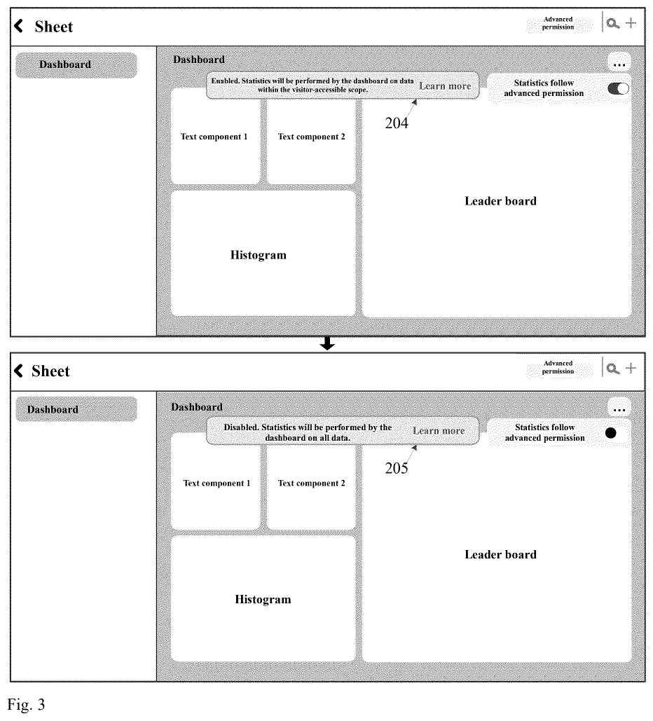

In the present application, for the switch component displayed by the second terminal, when it is detected that the switch component is in the on state, the first prompt information (the prompt information 204 shown in FIG. 3) may be displayed, so that the first prompt information may convey, to the manager, that the dashboard displayed by each first terminal is subsequently constrained by using the permission information.

In addition, the present application does not limit an implementation of the foregoing S103. For example, the step may be specifically: the second terminal displays the first prompt information in response to switching the switch component from an off state to the on state, so that the first prompt information is used to indicate that the permission information is used to constrain the dashboard displayed in the first terminal.

It may be learned that for the switch component displayed by using the dashboard, if it is detected that the switch component is switched from the off state to the on state, it may be determined that the switch component is already enabled. Therefore, the first prompt information (the prompt information 204 shown in FIG. 3) may be displayed, so that the first prompt information may convey, to the manager, that the dashboard displayed by each first terminal is subsequently constrained by using the permission information, so that the manager may learn from the first prompt information that statistics data of the current dashboard is already switched from all data to data that the viewer has permission to access.

It may be learned from the foregoing related content of S101 to S103 that the sheet data processing method provided in the present application includes: for a second terminal of a data sheet, when permission information is preconfigured for the data sheet, and the permission information is used to indicate an access permission of each first terminal for data in the data sheet, if the second terminal detects that the permission information is in an effective state, the second terminal displays not only a dashboard configured to describe a data analysis result for the data sheet, but also a switch component, so that a manager may use the switch component to flexibly configure whether the permission information is used to constrain the dashboard displayed by each first terminal. In this way, it may be implemented, from a dashboard dimension, to flexibly configure whether data used for statistics of the dashboard is all the data in the data sheet or data that a viewer has permission to access, so that content displayed in the dashboard may be efficiently and flexibly adjusted based on requirements of different scenarios (such as a general disclosure scenario or a scenario in which a role attribute is considered), thereby effectively improving user experience.

In addition, to better improve flexibility, the sheet data processing method may further include the following step 1.

Step 1: The second terminal displays second prompt information in response to the switch component being in the off state, where the second prompt information is used to indicate that the permission information is not used to constrain the dashboard displayed in the first terminal.

In the present application, for the switch component displayed by the second terminal, when it is detected that the switch component is in the off state, the second prompt information (the prompt information 205 shown in FIG. 3) may be displayed, so that the second prompt information may convey, to the manager, that the dashboard displayed by each first terminal is subsequently not constrained by using the permission information.

In addition, the present application does not limit an implementation of step 1. For example, step 1 may be specifically: displaying the second prompt information in response to switching the switch component from the on state to the off state, where the second prompt information is used to indicate that the permission information is not used to constrain the dashboard displayed in the first terminal.

It may be learned that for the switch component displayed by using the dashboard, if it is detected that the switch component is switched from the on state to the off state, it may be determined that the switch component is already disabled. Therefore, the second prompt information (the prompt information 205 shown in FIG. 3) may be displayed, so that the second prompt information may convey, to the manager, that the dashboard displayed by each first terminal is subsequently not constrained by using the permission information, so that the manager may learn from the second prompt information that statistics data of the current dashboard is already switched from data that the viewer has permission to access to all data.

In addition, in some scenarios, to better improve user experience, the first prompt information and the second prompt information each include an entry identification (the entry identification “learn more” shown in FIG. 3) of a same page, so that the user may enter a corresponding page, such as a display page of a help center document, through the identification. It should be noted that the present application does not limit an implementation of the identification. For example, the identification may be implemented by using an access link to the help center document. In addition, the link needs to support at least multiple languages.

In addition, for a dashboard obtained by performing statistical analysis on a data sheet, if it is detected that a terminal configured to display the dashboard has a management permission for the data sheet, and permission information preconfigured for the data sheet is in an invalid state, it may be determined that it is not necessary to use the permission information to constrain an access permission of a viewer, and therefore it may be determined that the viewer may access all data in the data sheet, and then it may be determined that the dashboard is used to perform statistics on all data. Therefore, the switch component may not be displayed, to avoid confusion of the user, which is favorable for better improving user experience.

It may be learned based on this that in a possible implementation, the sheet data processing method may include at least the foregoing S101 and S102 and the following step 11. An execution time of step 11 is later than an execution time of S102.

Step 11: The second terminal cancels displaying the switch component in response to switching the permission information from the effective state to an invalid state.

Example 1: When the switch component is directly deployed on the dashboard, step 11 may be specifically: the second terminal cancels displaying the switch component on the dashboard in response to switching the permission information from the effective state to the invalid state.

Example 2: When the switch component is deployed on the management page (the page 202 shown in FIG. 2), step 11 may be specifically: the second terminal cancels displaying the switch component on the management page in response to switching the permission information from the effective state to the invalid state.

It may be learned from the foregoing related content of step 11 that for the dashboard that is displayed by the second terminal and that is configured to describe the data analysis result for the data sheet, if it is detected that the permission information preconfigured for the data sheet is switched from the effective state to the invalid state, it may be determined that it is not necessary to use the permission information to constrain the data access permission of the viewer, and therefore it may be determined that the dashboard is used to perform statistics on all data, and then it may be determined that it is not necessary for the manager to manually select the statistics mode of the dashboard. Therefore, the switch component that has lost the use value may be directly canceled to display, to effectively avoid interference caused by the switch component, which is favorable for better improving user experience.

Research has found that in some scenarios, the manager may re-enable the advanced permission. Therefore, to better improve user experience, the state of the switch component when the advanced permission was last disabled may be continued.

It may be learned that in a possible implementation, the sheet data processing method may include at least the foregoing S101 and S102 and the following steps 21 and 22.

Step 21: The second terminal saves a state of the switch component and cancels displaying the switch component in response to switching the permission information from the effective state to the invalid state, so that the saved state may represent a state (such as an on state or an off state) of the switch component when the switch component is canceled to display.

Step 22: The second terminal displays the switch component according to the saved state in response to switching the permission information from the invalid state to the effective state, so that the switch component that is re-displayed may be restored to the state of the switch component when the advanced permission was last disabled.

It may be learned from the foregoing related content of steps 21 and 22 that for the dashboard that is displayed by the second terminal and that is configured to describe the data analysis result for the data sheet, if it is detected that the permission information preconfigured for the data sheet is switched from the effective state to the invalid state, not only displaying the switch component needs to be canceled, but also the state of the switch component needs to be saved, so that the saved state may represent the state of the switch component when the advanced permission is disabled, so that when it is detected that the permission information is re-switched from the invalid state to the effective state, the switch component may be directly restored and displayed according to the saved state, so that the re-displayed switch component may retain the state of the switch component when the advanced permission was last disabled, thereby effectively avoiding defects caused by reusing the switch component for configuration, which is favorable for better improving user experience.

Research has found that in some scenarios, such as a scenario in which there are a plurality of managers or a scenario in which the same terminal allows a plurality of requests to be triggered simultaneously, the following phenomenon may occur: a plurality of conflicting requests are triggered simultaneously (for example, two requests of disabling the advanced permission and enabling the switch component are triggered simultaneously, or two requests of canceling a management permission of a terminal and the terminal that has the management permission canceled triggering enabling the switch component are triggered simultaneously), which easily leads to confusion.

Based on the above research, to overcome the defects shown in the preceding paragraph, the sheet data processing method provided in the present application may include at least the following step 31 and/or step 32. An execution time of step 31 has no relation with an execution time of step 32. For example, the two execution times may be the same, the execution time of step 31 may be earlier than the execution time of step 32, or the execution time of step 32 may be earlier than the execution time of step 31. This is not limited in the present application.

Step 31: If a state switch request triggered for the switch component and a first request for requesting to switch the permission information from the effective state to an invalid state are detected simultaneously, execute the first request and display third prompt information, where the third prompt information is used to indicate that execution of the state switch request fails because the permission information is in the invalid state, and the state switch request is used to request to switch the switch component from the off state to the on state, or to switch the switch component from the on state to the off state.

It should be noted that the present application does not limit an implementation of step 31. For ease of understanding, the following describes two cases.

Case 1: In some scenarios, such as a scenario in which the same terminal allows a plurality of requests to be triggered simultaneously, step 31 may be specifically as follows: For a second terminal 1 that is displaying the switch component, at the same moment when the state switch request (such as a request to switch from the off state to the on state, or to switch from the on state to the off state) is triggered for the switch component by using the second terminal 1, the first request for requesting to switch the permission information from the effective state to the invalid state is further triggered by using the second terminal 1. In this case, it is detected that there is a conflict between execution processes of the two requests. Therefore, the first request with a higher priority may be first executed to switch the permission information from the effective state to the invalid state, so that the switch component does not meet the display condition, and the state switch request triggered for the switch component loses the value of execution. It is only necessary to directly display a prompt “operation fails, the current data sheet does not enable the advanced permission” on the second terminal 1, so that the second terminal 1 may learn from the prompt that a state of the permission information for the data sheet has changed.

Case 2: In some scenarios, such as a scenario in which there are a plurality of managers, step 31 may be specifically as follows: For a second terminal 1 that is displaying the switch component, at the same moment when the state switch request is triggered for the switch component by using the second terminal 1, the first request for requesting to switch the permission information from the effective state to the invalid state is triggered by using another second terminal (such as a second terminal 2). In this case, it is detected that there is a conflict between execution processes of the two requests. Therefore, the first request with a higher priority may be first executed to switch the permission information from the effective state to the invalid state, so that the switch component does not meet the display condition, and the state switch request triggered for the switch component loses the value of execution. It is only necessary to directly display a prompt “operation fails, the current data sheet does not enable the advanced permission” on the second terminal 1, so that the second terminal 1 may learn from the prompt that a state of the permission information for the data sheet has changed.

Step 32: If the state switch request triggered for the switch component and a second request for requesting to cancel the management permission of the second terminal for the data sheet are detected simultaneously, execute the second request and display fourth prompt information, where the fourth prompt information is used to indicate that execution of the state switch request fails because the second terminal does not have the management permission for the data sheet, and the state switch request is used to request to switch the switch component from the off state to the on state, or to switch the switch component from the on state to the off state.

It should be noted that the present application does not limit an implementation of step 32. For ease of understanding, the following describes two cases.

Case 1: In some scenarios, such as a scenario in which the same terminal allows a plurality of requests to be triggered simultaneously, step 32 may be specifically as follows: For a second terminal 1 that is displaying the switch component, at the same moment when the state switch request is triggered for the switch component by using the second terminal 1, a second request for requesting to cancel the management permission of the second terminal 1 for the data sheet is further triggered by using the second terminal 1. In this case, it is detected that there is a conflict between execution processes of the two requests. Therefore, the second request with a higher priority may be first executed to cancel the management permission of the second terminal 1 for the data sheet, so that the second terminal 1 no longer has the management permission for the data sheet, and the state switch request triggered by the second terminal 1 is not allowed by its permission, and thus the state switch request loses the value of execution. It is only necessary to directly display a prompt “operation fails, no permission to operate” on the second terminal 1, so that the second terminal 1 may learn from the prompt that it no longer has the management permission for the data sheet.

Case 2: In some scenarios, such as a scenario in which there are a plurality of managers, step 32 may be specifically as follows: For a second terminal 1 that is displaying the switch component, at the same moment when the state switch request is triggered for the switch component by using the second terminal 1, a second request for requesting to cancel the management permission of the second terminal 1 for the data sheet is triggered by using another second terminal (such as a second terminal 2). In this case, it is detected that there is a conflict between execution processes of the two requests. Therefore, the second request with a higher priority may be first executed to cancel the management permission of the second terminal 1 for the data sheet, so that the second terminal 1 no longer has the management permission for the data sheet, and the state switch request triggered by the second terminal 1 is not allowed by its permission, and thus the state switch request loses the value of execution. It is only necessary to directly display a prompt “operation fails, no permission to operate” on the second terminal 1, so that the second terminal 1 may learn from the prompt that it no longer has the management permission for the data sheet.

It may be learned from the foregoing related content of steps 31 and 32 that for a plurality of requests triggered simultaneously by the same second terminal or different requests triggered simultaneously by different terminal devices, if it is detected that there is a conflict between the requests, the requests may be sequentially processed based on priorities, to avoid defects (such as confusion or insecurity) caused by simultaneously processing the requests.

Research has found that in some scenarios, there may be the following requirement: a manager needs to preview in advance whether a dashboard that may be seen by different users meets expectations of the manager.

Based on the above research, to better satisfy the requirement shown in the preceding paragraph, the present application provides a possible implementation of the sheet data processing method. In this implementation, when the data sheet is preconfigured with a plurality of first terminals, the sheet data processing method may include at least the following steps 41 and 42.

Step 41: The second terminal displays a preview page in response to a preview operation triggered for the dashboard, where the preview page displays, by default, a display effect of the dashboard on a third terminal, and the plurality of first terminals include the third terminal.

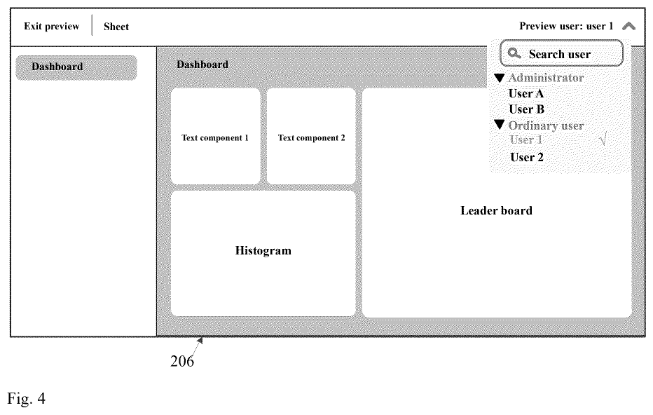

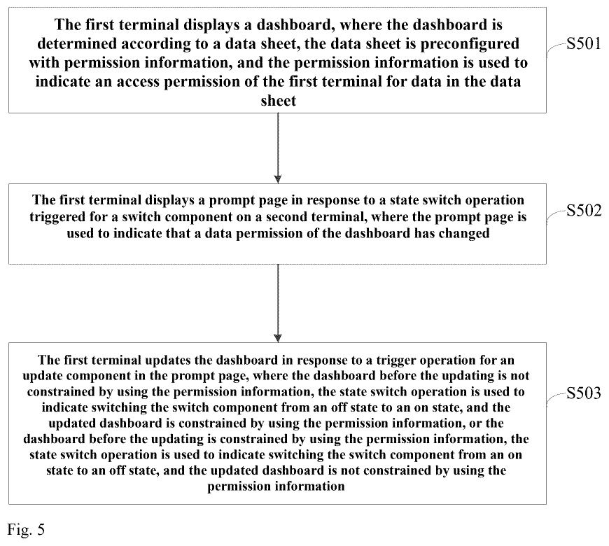

The preview operation is used to trigger a display process of the preview page, and the present application does not limit the preview operation. For example, the preview operation may be: first clicking the “advanced permission” button shown in FIG. 2 to open an option aggregation page; and then clicking a preview option displayed by the option aggregation page to enter the preview page, for example, the page 206 shown in FIG. 4.

In addition, the third terminal refers to the first terminal to which the dashboard displayed by default (or initially) by the preview page belongs when the preview page is entered, for example, the second terminal, any one of the plurality of first terminals, or a terminal specified by the user through configuration.

Step 42: The second terminal updates the preview page in response to a preview object switch operation triggered for the preview page, where the preview object switch operation is used to indicate switching from the third terminal to a fourth terminal, the plurality of first terminals include the fourth terminal, and the updated preview page is used to display a display effect of the dashboard on the fourth terminal.

The preview object switch operation is used to indicate switching from the third terminal to the fourth terminal, so that the operation is used to request to replace the content displayed by the preview page, for example, switch from the dashboard displayed by the third terminal (user A shown in FIG. 4) to the dashboard displayed by the fourth terminal (user 1 shown in FIG. 4).

The fourth terminal refers to a preview object specified by the preview object switch operation, for example, the user 1 shown in FIG. 4.

It may be learned from the foregoing related content of steps 41 and 42 that the second terminal may enter the preview mode by using this terminal, to confirm, in this mode, whether the dashboard seen by each viewer meets his/her expectations, which is favorable for improving management experience.

In addition, the present application does not limit an application scenario of the preview process described in steps 41 and 42. For example, the application scenario may be as follows: For the second terminal that is displaying the switch component, if the terminal detects that the switch component is in the on state, a new component (such as the preview option) may be added to the dashboard displayed by the terminal, so that the preview process may be subsequently entered by using the component to trigger the preview operation. In this way, the manager may use the preview mode to confirm whether the dashboard seen by any viewer meets the access permission set for the viewer, to ensure that the preview service is provided only in the scenario in which the dashboard is generated based on data that the viewer has permission to access, thereby avoiding interference of the related content of the component with the scenario in which the dashboard is generated based on all the data.

Research has found that if there is another terminal accessing a dashboard during a period when a second terminal adjusts a statistics manner of the dashboard, it is necessary to update in a timely manner the dashboard displayed by the another terminal, to overcome defects (such as insecurity) caused by untimely update of the dashboard.

Based on the above research, the present application further provides a sheet data processing method applied to a first terminal, including the following S501 to S503.

S501: The first terminal displays a dashboard, where the dashboard is determined according to a data sheet, the data sheet is preconfigured with permission information, and the permission information is used to indicate an access permission of the first terminal for data in the data sheet.

S502: The first terminal displays a prompt page in response to a state switch operation triggered for a switch component on a second terminal, where the prompt page is used to indicate that a data permission of the dashboard has changed.

The state switch operation refers to an operation that is triggered for the second terminal during a period when the first terminal displays the dashboard and that is used to adjust a state in which the switch component is located.

It may be learned that if the dashboard displayed by the first terminal is not constrained by the dashboard being displayed by the first terminal by using the permission information, it may be determined that the switch component is adjusted to an off state by using the second terminal in historical time, and therefore it may be determined that the state switch operation is used to indicate switching the switch component displayed by the second terminal from the off state to an on state. However, if the dashboard displayed by the first terminal is constrained by the dashboard being displayed by the first terminal by using the permission information, it may be determined that the switch component is adjusted to the on state by using the second terminal in historical time, and therefore it may be determined that the state switch operation is used to indicate switching the switch component displayed by the second terminal from the on state to the off state.

In addition, the present application does not limit an implementation of the prompt page. For example, the prompt page may be implemented by using a pop-up window. Copy of the pop-up window may be “the data permission of the dashboard has been modified, please view after refreshing”. The pop-up window further includes a refresh button, so that the user may subsequently click the button to update the dashboard.

S503: The first terminal updates the dashboard in response to a trigger operation for an update component in the prompt page, where the dashboard before the updating is not constrained by using the permission information, the state switch operation is used to indicate switching the switch component from the off state to the on state, and the updated dashboard is constrained by using the permission information, or the dashboard before the updating is constrained by using the permission information, the state switch operation is used to indicate switching the switch component from the on state to the off state, and the updated dashboard is not constrained by using the permission information.

The update component refers to a component that exists on the prompt page and that is used to trigger a dashboard update process, for example, the refresh button.

In addition, the present application does not limit an implementation of the step “updating the dashboard”. For example, the implementation may meet the following constraints: If the dashboard before the updating is not constrained by using the permission information, and the state switch operation is used to indicate switching the switch component from the off state to the on state, the updated dashboard is constrained by using the permission information; or if the dashboard before the updating is constrained by using the permission information, and the state switch operation is used to indicate switching the switch component from the on state to the off state, the updated dashboard is not constrained by using the permission information.

It may be learned from the foregoing related content of S501 to S503 that for any first terminal, during a period when the first terminal browses the dashboard, if the second terminal triggers the state switch operation for the switch component displayed by the second terminal, it may be determined that the second terminal adjusts the statistics manner of the dashboard. Therefore, the pop-up window may be displayed on the first terminal to prompt the user to refresh, so that the viewer may use the refresh button on the pop-up window to trigger the update process of the dashboard, so that the viewer may continue to browse the updated dashboard. In this way, the dashboard in each first terminal may be updated in a timely manner, which is favorable for better improving user experience.

In addition, the present application does not limit an implementation of using the permission information to constrain the dashboard. For example, the implementation may be specifically as follows: For any component in the dashboard, if it is detected that data (such as intermediate data or finally displayed data) involved in a determination process of the data analysis result displayed by the component includes data that the viewer does not have permission to access, the component cannot be displayed, but a preset “no permission to view” bottoming graph is directly displayed at a display position of the component, to notify the viewer that he/she does not have permission to view the component.

Research has further found that if intermediate data involved in a rendering process (such as a determination process of the data analysis result displayed by the component) of a component includes data that the viewer does not have permission to access, but the final rendering result of the component does not include the data that the viewer does not have permission to access, there is no risk of leaking the data that the viewer does not have permission to access to the viewer when the component is displayed, so that the component should be displayed to the viewer, and should not be replaced with the preset “no permission to view” bottoming graph, which is favorable for better improving user experience.

Based on the above research, to better improve user experience, the present application further provides an implementation solution of using permission information to constrain components on a dashboard. In this solution, if the permission information indicates that a first terminal has no permission to access a first data set (such as any invisible column or any invisible row) in a data sheet, and the first data set includes any column or any row in the data sheet, for any component in the dashboard, a process of determining content displayed on the component includes:
when key information for rendering the component is used to form a data analysis result displayed by the component, so that a user may directly see the key information on the component, if the key information includes the first data set, it may be determined that the content displayed on the component includes data that a viewer has no permission to view. Therefore, preset content (such as content such as a “no permission to view” bottoming graph) may be used to replace the component for display, so that the preset content is used to indicate that the first terminal has no permission to view the data analysis result, thereby preventing the viewer from seeing, on the component, the data that he/she has no permission to access; or if the key information does not include the first data set, it may be determined that the content displayed on the component does not include data that the viewer has no permission to view. Even if the first data set is used in a process of obtaining the content displayed on the component, the first data set is not directly exposed by the component, so that the viewer still cannot see the first data set through the component. Therefore, the component may be rendered and displayed according to the data sheet. In this way, it may be implemented to display as many data analysis results as possible while preventing data that the viewer has no permission to access from being exposed. For ease of understanding, the following describes three cases.

Case 1: For any component in the dashboard displayed by the first terminal, if there is an invisible column (or an invisible row) in key information (such as a component of the data analysis result displayed by the component) on which rendering the component depends, it may be determined that the component has a risk of exposing data that the viewer has no permission to access. Therefore, the component may not be displayed, but the “no permission to view” bottoming graph may be directly displayed at a display position of the component.

It should be noted that because different components have different characteristics, key information of the different components is different, resulting in a difference in processing standards for the different components, as shown in the following (1) to (3).

(1) For a first-type component (such as a coordinate axis component, a pie chart, or a ring chart), if content displayed by the component includes key information of the component, so that a user may directly see the key information through the component, when it is detected that an invisible column is used in the key information, it may be determined that the component cannot be normally displayed, and the component may be replaced with the “no permission to view” bottoming graph. The key information may include a category (such as an X axis) involved in the coordinate axis component, a series (such as a Y axis) involved in the coordinate axis component, a grouping basis involved in the coordinate axis component, sector grouping involved in the pie chart (or the ring chart), a sector value involved in the pie chart (or the ring chart), and the like.

(2) For a second-type component (such as a funnel chart, a word cloud, an indicator card, a leader board, or an NPS chart), if content displayed by the component is obtained by processing key information of the component, so that the user may directly see a processing result of the key information through the component, when it is detected that an invisible column is used in the key information, it may be determined that the component cannot be normally displayed, and the component may be replaced with the “no permission to view” bottoming graph. The key information may include a funnel layer of the funnel chart or data statistics, a keyword field of the word cloud, a statistics manner of the indicator card, a ranking field or a ranking basis of the leader board, an NPS basis of the NPS chart, and the like.

(3) For a third-type component (such as a text component or a button component), because content displayed by the component may hardly involve a specific data column (such as an invisible column) in the data sheet, and may hardly involve a processing result of the data column, key information used for rendering the component is not related to the invisible column, so that the component is not affected by the invisible column.

It should be further noted that for any component, the key information used for rendering the component may be manually preset, or may be determined based on an attribute of the component, which is not specifically limited in the present application.

Case 2: For any component in the dashboard displayed by the first terminal, if there is no invisible column (or invisible row) in the key information on which rendering the component depends, but the invisible column (or the invisible row) is used in the rendering process of the component, it may be determined that the invisible column (or the invisible row) is not exposed when the component is displayed. Therefore, the component may be directly and normally displayed. For example, if the column “region” shown in the above Table 1 belongs to an invisible column, when a filter condition corresponding to the component is region=region 1, a category corresponding to the component is the sales date, and a series corresponding to the component is the sales amount, filtering is effective, and the component is normally rendered, so that the rendered component meets the following constraints: the category includes a sales date of region 1, and the series includes a sales amount of region 1. In addition, drill-down data of the component is only used to display the second row to the sixth row in Table 1, but the column of region needs to be hidden.

It should be noted that for any component, when an intermediate process involved in rendering the component includes global filtering or component filtering or component data sorting, if an invisible column is used for filtering or sorting, a filtering result and a sorting result may be normally returned, and subsequent rendering processing may be continued to be performed based on the results, as long as it is ensured that data in the invisible column and a processing result of the invisible column do not appear on the finally rendered component.

It should be further noted that for any component, when there is a drill-down pop-up window for a chart displayed by the component, if the pop-up window displays chart calculation data after filtering and sorting, the invisible column in the data source is hidden, and a row after a filter condition or a sorting condition is effective is displayed.

Case 3: For any component in the dashboard displayed by the first terminal, if there is no invisible column (or invisible row) in the key information on which rendering the component depends, and the invisible column (or the invisible row) is not used in the rendering process of the component, it may be determined that the component is not related to the invisible column (or the invisible row). Therefore, the component may be directly and normally displayed.

Research has found that in some scenarios, for example, a scenario in which a user has a plurality of role attributes, the user's data access permission for a data sheet is a union of data access permissions of all the role attributes, so that the user's data access permission for the data sheet may have a grid masking column (or a grid masking row). For example, the user has permission to view some data in a specific column (for example, the first six pieces of data in the column “profit” in the above Table 1), making it difficult to use the grid masking column when a dashboard is generated. The grid masking column, also referred to as a partially visible column, refers to a data column in which some data is visible but some other data is invisible, so that the grid masking column seen from a viewer's perspective is in a state in which some grids have data but some grids have no data.

Based on the above research, to solve the problem shown in the preceding paragraph, the present application further provides a solution to the above grid masking column. In this solution, when permission information is used to constrain components on a dashboard, if the permission information indicates that a first terminal has no permission to access some data in a second data set (such as a grid masking column or a grid masking row) in the data sheet, and the second data set includes any column or any row in the data sheet, for any component in the dashboard, a process of determining content displayed on the component includes:
when key information for rendering the component is used to form a data analysis result displayed by the component, so that a user may directly see the key information on the component, if the key information includes the second data set, rendering the component according to data other than the some data in the second data set and displaying the component, so that the content displayed by the component does not include the some data; if the key information does not include the second data set, but a rendering process of the component uses the second data set, rendering the component according to data other than the some data in the second data set and displaying the component, so that the content displayed by the component does not include the some data; or if the key information does not include the second data set, and the second data set is not used in the rendering process of the component, rendering the component according to the data sheet and displaying the component. For ease of understanding, the following describes three cases.

Case 1: For any component in the dashboard displayed by the first terminal, if there is a grid masking column (or a grid masking row) in key information on which rendering the component depends, it may be determined that some of content displayed by the component may be displayed, but some of the content cannot be displayed. Therefore, data that the viewer has permission to access in the grid masking column (or the grid masking row) may be used to participate in statistical processing, to obtain the component, so that the component is only used to display content related to the data that the viewer has permission to access (also referred to as visible data), and does not display content related to data that the viewer has no permission to access (also referred to as invisible data). For example, if the column “profit” shown in the above Table 1 belongs to a grid masking column, and the first six pieces of data in the grid masking column belong to data that the viewer has permission to access, and the other data belongs to data that the viewer has no permission to access, when the key information on which rendering the component depends uses the grid masking column, a category corresponding to the component is the sales date, and a series corresponding to the component is the profit, the component is rendered according to a statistical analysis result between the second row and the seventh row in Table 1, so that the rendered component meets the following constraints: the category is used to describe a sales date involved in the second row to the seventh row, and the series is used to describe a profit involved in the second row to the seventh row. In this way, drill-down data of the component is only used to display the second row to the seventh row in Table 1.

It should be noted that because different components have different characteristics, key information of the different components is different, resulting in a difference in processing standards for the different components. Specifically, if the key information of the first-type component or the second-type component uses a grid masking column, the component is rendered based on visible data in the grid masking column; and the third-type component is not affected by the grid masking column. In addition, for a fourth-type component, for example, a view component, if grouping uses a grid masking column, content displayed by the component is grouped by using a data row in which visible data in the grid masking column is located; if a parent record of a table is set to a grid masking column, the component is used to display data in which a data row in which visible data in the grid masking column is located is used as the parent record; if a date uses a grid masking column when a gantt chart date is configured, the component is used to display a data row in which visible data in the grid masking column is located; if a visible field uses a grid masking column, the component is used to display a data row in which visible data in the grid masking column is located; or if a kanban or an album cover uses a grid masking column, the component is used to display a cover of a data row in which visible data in the grid masking column is located, and a row that has no permission is considered as not configured.

Case 2: For any component in the dashboard displayed by the first terminal, if there is no grid masking column (or grid masking row) in the key information on which rendering the component depends, but the grid masking column (or the grid masking row) is used in the rendering process of the component, visible data in the grid masking column (or the grid masking row) may be used to participate in the rendering process, to obtain and display the component, so that the component is only used to display a data analysis result determined based on the visible data. For example, if the column “profit” shown in the above Table 1 belongs to a grid masking column, and the first six pieces of data in the grid masking column are visible, and the other data is invisible, when a filter condition corresponding to the component is profit >200, a category corresponding to the component is the sales date, and a series corresponding to the component is the sales amount, filtering is effective, and the component is rendered by filtering only the second row to the seventh row in Table 1, so that the rendered component meets the following constraints: the category includes 2024 Nov. 2, 2024 Nov. 4, and 2024 Nov. 6, and the series includes 203, 500, and 300. In this way, drill-down data of the component is only used for the second row to the seventh row in Table 1.

It should be noted that for any component, when an intermediate process involved in rendering the component includes global filtering or component filtering or component data sorting, if a grid masking column is used for filtering or sorting, a data row in which visible data in the grid masking column is located may be used to participate in filtering and sorting, and subsequent rendering processing may be continued to be performed based on a returned result.

It should be further noted that for any component, when there is a drill-down pop-up window for a chart displayed by the component, if drill-down data displayed by the pop-up window includes a grid masking column, only visible data in a filtered column is displayed.

It may be learned based on the above content that the technical solution provided in the present application has the following advantages: \textcircled{1} In the present application, whether data statistics is performed on all data or data that a viewer has permission to access is configured from a dashboard dimension, so that a user may flexibly choose to use all the data or the data that the viewer has permission to access for statistics based on different usage scenarios (such as a general disclosure scenario or a multi-role attribute scenario) of the dashboard. This helps improve flexibility of scenario switching. \textcircled{2} In the present application, when any component on the dashboard is rendered, if an intermediate process (such as filtering or sorting) involved in the component uses an invisible column, the intermediate process may be normally performed, as long as it is ensured that the finally rendered component does not display the invisible column. In this way, the viewer may only see a final rendering result, and cannot perceive the intermediate process. This helps better improve user experience. \textcircled{3} The present application further provides a processing manner for a grid masking column or a grid masking row, so that the processing manner may satisfy a requirement in a scenario in which permission configuration of data that the viewer has permission to access is refined to a cell, so that the present application is applicable to a scenario of role intersection that occurs because a same user has a plurality of role attributes, for example, a scenario in which a grid masking column exists.

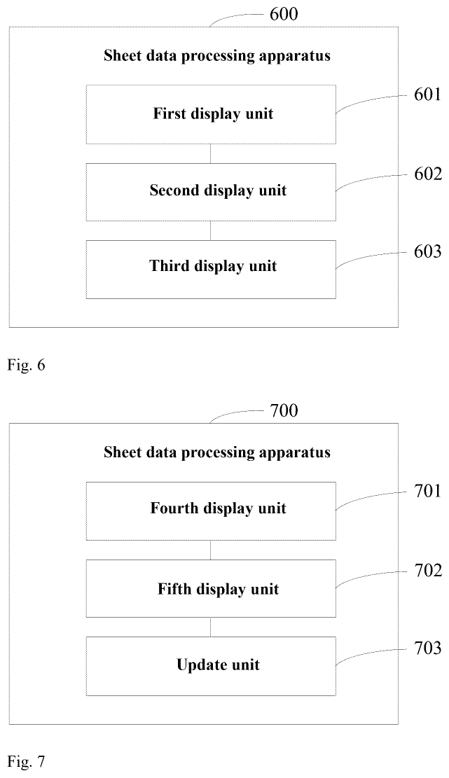

Based on the sheet data processing method provided in the embodiments of the present application, an embodiment of the present application further provides a sheet data processing apparatus. The following explains and describes the apparatus with reference to FIG. 6. FIG. 6 is a schematic diagram of a structure of a sheet data processing apparatus according to an embodiment of the present application. It should be noted that for technical details of the sheet data processing apparatus provided in the embodiment of the present application, reference may be made to the related content of the sheet data processing method described above.

As shown in FIG. 6, the sheet data processing apparatus 600 provided in the embodiment of the present application includes:
a first display unit 601, configured to display a dashboard, where the dashboard is configured to describe a data analysis result for a data sheet, the data sheet is preconfigured with permission information, and the permission information is used to indicate an access permission of a first terminal for data in the data sheet;
a second display unit 602, configured to display a switch component in response to the permission information being in an effective state, where the switch component is used to use the permission information to constrain the dashboard displayed in the first terminal; and
a third display unit 603, configured to display first prompt information in response to the switch component being in an on state, where the first prompt information is used to indicate that the permission information is used to constrain the dashboard displayed in the first terminal.

In a possible implementation, the third display unit 603 is further configured to display second prompt information in response to the switch component being in an off state, where the second prompt information is used to indicate that the permission information is not used to constrain the dashboard displayed in the first terminal.

In a possible implementation, the second display unit 602 is further configured to: in response to the permission information being in the effective state, add to display the switch component on the dashboard.

In a possible implementation, an entry identification of a management page is displayed on the dashboard, and the second display unit 602 is further configured to: in response to a trigger operation for the entry identification, display the management page, and in response to the permission information being in the effective state, add to display the switch component on the management page.

In a possible implementation, the sheet data processing apparatus 600 further includes a first cancellation unit. The first cancellation unit is configured to, after the switch component is added to be displayed on the dashboard, cancel displaying the switch component on the dashboard in response to switching the permission information from the effective state to an invalid state.

In a possible implementation, the sheet data processing apparatus 600 further includes a second cancellation unit. The second cancellation unit is configured to, after the switch component is added to be displayed on the management page, cancel displaying the switch component on the management page in response to switching the permission information from the effective state to an invalid state.

In a possible implementation, the sheet data processing apparatus 600 further includes a third cancellation unit and a restoration display unit. The third cancellation unit is configured to save a state of the switch component and cancel displaying the switch component in response to switching the permission information from the effective state to an invalid state. The restoration display unit is configured to display the switch component according to the saved state of the switch component in response to switching the permission information from the invalid state to the effective state.

In a possible implementation, the sheet data processing apparatus 600 further includes a first processing unit. The first processing unit is configured to: if a state switch request triggered for the switch component and a first request for requesting to switch the permission information from the effective state to an invalid state are detected simultaneously, execute the first request and display third prompt information, where the third prompt information is used to indicate that execution of the state switch request fails because the permission information is in the invalid state, and the state switch request is used to request to switch the switch component from the off state to the on state, or to switch the switch component from the on state to the off state.

In a possible implementation, the sheet data processing apparatus 600 further includes a second processing unit. The second processing unit is configured to: if the state switch request triggered for the switch component and a second request for requesting to cancel the management permission of the second terminal for the data sheet are detected simultaneously, execute the second request and display fourth prompt information, where the fourth prompt information is used to indicate that execution of the state switch request fails because the second terminal does not have the management permission for the data sheet, and the state switch request is used to request to switch the switch component from the off state to the on state, or to switch the switch component from the on state to the off state.

In a possible implementation, different requests are triggered by different terminals, and the state switch request is triggered by the second terminal.

In a possible implementation, the data sheet is preconfigured with a plurality of first terminals, and the sheet data processing apparatus 600 further includes a preview trigger unit and an object switch unit. The preview trigger unit is configured to display a preview page in response to a preview operation triggered for the dashboard, where the preview page displays, by default, a display effect of the dashboard on a third terminal, and the plurality of first terminals include the third terminal. The object switch unit is configured to update the preview page in response to a preview object switch operation triggered for the preview page, where the preview object switch operation is used to indicate switching from the third terminal to a fourth terminal, the plurality of first terminals include the fourth terminal, and the updated preview page is used to display a display effect of the dashboard on the fourth terminal.

It may be learned based on the related content of the sheet data processing apparatus 600 described above that the working principle of the apparatus 600 includes: When the permission information is preconfigured for the data sheet, and the permission information is used to indicate the access permission of each first terminal for the data in the data sheet, if the second terminal detects that the permission information is in the effective state, the second terminal displays not only the dashboard configured to describe the data analysis result for the data sheet, but also the switch component, so that the manager may use the switch component to flexibly configure whether the permission information is used to constrain the dashboard displayed by each first terminal. In this way, it may be implemented, from the dashboard dimension, to flexibly configure whether the data used for the statistics of the dashboard is all the data in the data sheet or the data that the viewer has permission to access, so that the content displayed in the dashboard may be efficiently and flexibly adjusted based on the requirements of different scenarios (such as the general disclosure scenario or the scenario in which the role attribute is considered), thereby effectively improving the user experience.

Based on the sheet data processing method provided in the embodiments of the present application, an embodiment of the present application further provides a sheet data processing apparatus. The following explains and describes the apparatus with reference to FIG. 7. FIG. 7 is a schematic diagram of a structure of a sheet data processing apparatus according to an embodiment of the present application. It should be noted that for technical details of the sheet data processing apparatus provided in the embodiment of the present application, reference may be made to the related content of the sheet data processing method described above.

As shown in FIG. 7, the sheet data processing apparatus 700 provided in the embodiment of the present application includes:
a fourth display unit 701, configured to display a dashboard, where the dashboard is determined according to a data sheet, the data sheet is preconfigured with permission information, and the permission information is used to indicate an access permission of the first terminal for data in the data sheet;
a fifth display unit 702, configured to display a prompt page in response to a state switch operation triggered for a switch component on a second terminal, where the prompt page is used to indicate that a data permission of the dashboard has changed; and
an update unit 703, configured to update the dashboard in response to a trigger operation for an update component in the prompt page, where the dashboard before the updating is not constrained by using the permission information, the state switch operation is used to indicate switching the switch component from an off state to an on state, and the updated dashboard is constrained by using the permission information, or the dashboard before the updating is constrained by using the permission information, the state switch operation is used to indicate switching the switch component from an on state to an off state, and the updated dashboard is not constrained by using the permission information.

In a possible implementation, the dashboard includes a plurality of components, and different components are used to display different data analysis results for the data sheet; and when the dashboard is constrained by using the permission information, if the permission information indicates that the first terminal has no permission to access a first data set in the data sheet, and the first data set includes any column or any row in the data sheet, for any component in the dashboard, a display process of the component includes: if key information for rendering the component includes the first data set, using preset content to replace the component for display, where the key information is used to form the data analysis result displayed by the component, and the preset content is used to indicate that the first terminal has no permission to view the data analysis result displayed by the component; and if the key information for rendering the component does not include the first data set, rendering the component according to the data sheet and displaying the component.

In a possible implementation, the dashboard includes a plurality of components, and different components are used to display different data analysis results for the data sheet; and when the dashboard is constrained by using the permission information, if the permission information indicates that the first terminal has no permission to access some data in a second data set in the data sheet, and the second data set includes any column or any row in the data sheet, for any component in the dashboard, a display process of the component includes: if key information for rendering the component includes the second data set, rendering the component according to data other than the some data in the second data set and displaying the component, where the key information is used to form the data analysis result displayed by the component; and if the key information for rendering the component does not include the second data set, but a rendering process of the component uses the second data set, rendering the component according to data other than the some data in the second data set and displaying the component.

It may be learned based on the related content of the sheet data processing apparatus 700 described above that the working principle of the apparatus 700 includes: During a period when a viewer browses the dashboard by using the apparatus 700, if the second terminal triggers the state switch operation for the switch component, it may be determined that the second terminal adjusts the statistics manner of the dashboard. Therefore, the pop-up window may be displayed on the apparatus 700 to prompt the user to refresh, so that the viewer may use the refresh button on the pop-up window to trigger the update process of the dashboard, so that the viewer may continue to browse the updated dashboard. In this way, the dashboard in a terminal other than the second terminal may be updated in a timely manner, which is favorable for better improving user experience.

In addition, an embodiment of the present application further provides an electronic device. The device includes a processor and a memory. The memory is configured to store an instruction or a computer program. The processor is configured to execute the instruction or the computer program in the memory, to enable the electronic device to perform any implementation of the sheet data processing method provided in the embodiments of the present application.

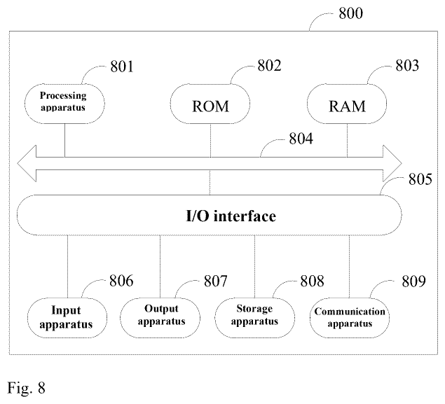

Referring to FIG. 8, FIG. 8 shows a schematic diagram of a structure of an electronic device 800 suitable for implementing an embodiment of the present disclosure. The terminal device in the embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and an in-vehicle terminal (for example, an in-vehicle navigation terminal), and fixed terminals such as a digital TV and a desktop computer. The electronic device shown in FIG. 8 is merely an example, and shall not impose any limitation on the function and scope of use of the embodiments of the present disclosure.

As shown in FIG. 8, the electronic device 800 may include a processing apparatus (for example, a central processing unit or a graphics processor) 801 that may perform various appropriate actions and processing according to a program stored in a read-only memory (ROM) 802 or a program loaded from a storage apparatus 808 into a random access memory (RAM) 803. The RAM 803 further stores various programs and data required for operations of the electronic device 800. The processing apparatus 801, the ROM 802, and the RAM 803 are interconnected by using a bus 804. An input/output (I/O) interface 805 is also connected to the bus 804.

Usually, the following apparatuses may be connected to the I/O interface 805: an input apparatus 806 including, for example, a touch screen, a touchpad, a keyboard, a mouse, a camera, a microphone, an accelerometer, or a gyroscope; an output apparatus 807 including, for example, a liquid crystal display (LCD), a speaker, or a vibrator; the storage apparatus 808 including, for example, a magnetic tape or a hard disk; and a communication apparatus 809. The communication apparatus 809 may allow the electronic device 800 to perform wireless or wired communication with another device, to exchange data. Although FIG. 8 shows the electronic device 800 having various apparatuses, it should be understood that it is not required to implement or have all the apparatuses shown. More or fewer apparatuses may be alternatively implemented or provided.

In particular, according to the embodiments of the present disclosure, the process described above with reference to the flowchart may be implemented as a computer software program. For example, an embodiment of the present disclosure includes a computer program product. The computer program product includes a computer program carried in a non-transitory computer-readable medium. The computer program includes program code for performing the method shown in the flowchart. In such an embodiment, the computer program may be downloaded from a network and installed through the communication apparatus 809, or may be installed from the storage apparatus 808, or may be installed from the ROM 802. When the computer program is executed by the processing apparatus 801, the foregoing functions limited in the method of the embodiments of the present disclosure are performed.

The electronic device provided in the embodiment of the present disclosure belongs to the same inventive concept as the method provided in the foregoing embodiments. For technical details not described in detail in this embodiment, reference may be made to the foregoing embodiments. This embodiment has the same beneficial effects as the foregoing embodiments.

An embodiment of the present application further provides a computer-readable medium having an instruction or a computer program stored thereon, where the instruction or the computer program, when executed by a device, enables the device to perform any implementation of the sheet data processing method provided in the embodiments of the present application.

It should be noted that the foregoing computer-readable medium in the present disclosure may be a computer-readable signal medium, a computer-readable storage medium, or any combination thereof. The computer-readable storage medium may be, for example, but is not limited to, an electronic, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that includes or stores a program, and the program may be used by or used in combination with an instruction execution system, apparatus, or device. In the present disclosure, the computer-readable signal medium may include a data signal propagated on a baseband or as a part of a carrier, and computer-readable program code is carried in the data signal. The data signal propagated in this way may be in a plurality of forms, and includes, but is not limited to, an electromagnetic signal, an optical signal, or any suitable combination thereof. The computer-readable signal medium may alternatively be any computer-readable medium other than the computer-readable storage medium, and the computer-readable signal medium may send, propagate, or transmit a program used by or in combination with an instruction execution system, apparatus, or device. The program code included in the computer-readable medium may be transmitted in any suitable medium, including but not limited to a wire, an optical cable, a radio frequency (RF), or any suitable combination thereof.

In some implementations, a client and a server may communicate using any currently known or future developed network protocol, such as the hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The computer-readable medium may be contained in the electronic device, or may exist alone without being assembled into the electronic device.

The computer-readable medium carries one or more programs, and the one or more programs, when executed by the electronic device, enable the electronic device to perform the foregoing method.

Computer program code for performing the operations in the present disclosure may be written in one or more programming languages or a combination thereof, where the one or more programming languages include, but are not limited to, an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagrams in the drawings illustrate the possibly implemented architectures, functions, and operations of the system, the method, and the computer program product according to various embodiments of the present disclosure. In this regard, each block in the flowchart or block diagrams may represent a module, program segment, or part of code, and the module, program segment, or part of code includes one or more executable instructions for implementing the specified logical functions. It should also be noted that, in some alternative implementations, functions indicated in the blocks may also occur in an order different from that indicated in the drawings. For example, two blocks shown in succession may actually be performed substantially in parallel, or they may sometimes be performed in the reverse order, depending on the functions involved. It should also be noted that each block in the block diagrams and/or the flowchart, and a combination of the blocks in the block diagrams and/or the flowchart may be implemented by a dedicated hardware-based system that executes specified functions or operations, or may be implemented by a combination of dedicated hardware and computer instructions.

The involved units described in the embodiments of the present disclosure may be implemented by software, and may also be implemented by hardware. The name of a unit/module does not constitute a limitation on the unit itself in some cases.

The functions described above herein may be performed at least partially by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD), and the like.

In the context of the present disclosure, the machine-readable medium may be a tangible medium, and may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

It should be noted that the embodiments in this specification are described in a progressive manner. Each embodiment focuses on a difference from another embodiment, and the same or similar parts between the embodiments may be referred to each other. For the system or apparatus disclosed in the embodiments, because it corresponds to the method disclosed in the embodiments, the description is relatively simple. For related parts, refer to the description of the method.

It should be understood that in the present application, “at least one item” means one or more, and “a plurality of” means two or more. The term “and/or” describes an association relationship between associated objects, and represents that three relationships may exist. For example, “A and/or B” may represent the following three cases: Only A exists, only B exists, and both A and B exist, where A and B may be singular or plural. The character “/” generally indicates an “or” relationship between the associated objects. At least one of the following items (pieces) or a similar expression thereof indicates any combination of these items, including a single item (piece) or any combination of a plurality of items (pieces). For example, at least one of a, b, or c may represent: a, b, c, “a and b”, “a and c”, “b and c”, or “a, b, and c”, where a, b, and c may be singular or plural.

It should be further noted that in this specification, relational terms such as first and second are used only to distinguish one entity or operation from another entity or operation, and do not necessarily require or imply any actual relationship or order between these entities or operations. Moreover, the terms “include”, “comprise”, or any other variant thereof are intended to cover non-exclusive inclusion, so that a process, method, object, or device that includes a series of elements includes not only those elements, but also other elements not expressly listed or elements inherent to such a process, method, object, or device. Without further restrictions, an element defined by the phrase “includes a” does not exclude that another same element exists in the process, method, object, or device that includes the element.

The steps of the method or algorithm described in conjunction with the embodiments disclosed herein may be directly implemented by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or a storage medium of any other form known in the art.

The foregoing descriptions of the disclosed embodiments enable those skilled in the art to implement or use the present application. Various modifications to these embodiments will be readily apparent to those skilled in the art, and the generic principles defined herein may be implemented in other embodiments without departing from the spirit or scope of the present application. Therefore, the present application is not limited to the embodiments shown herein, but is to be accorded the widest scope consistent with the principles and novel features disclosed herein.

1. A sheet data processing method, comprising:
displaying a dashboard, wherein the dashboard is configured to describe a data analysis result for a data sheet, the data sheet is preconfigured with permission information, and the permission information is used to indicate an access permission of a first terminal for data in the data sheet;
in response to the permission information being in an effective state, displaying a switch component, wherein the switch component is configured to use the permission information to constrain the dashboard displayed in the first terminal; and
in response to the switch component being in an on state, displaying first prompt information, wherein the first prompt information is used to indicate that the permission information is used to constrain the dashboard displayed in the first terminal.

2. The method of claim 1, wherein the method further comprises:
in response to the switch component being in an off state, displaying second prompt information, wherein the second prompt information is used to indicate that the permission information is not used to constrain the dashboard displayed in the first terminal.

3. The method of claim 1, wherein a display process of the switch component comprises:
in response to the permission information being in the effective state, adding to display the switch component on the dashboard;
or
an entry identification of a management page is displayed on the dashboard, and a display process of the switch component comprises:
in response to a trigger operation for the entry identification, displaying the management page, and in response to the permission information being in the effective state, adding to display the switch component on the management page.

4. The method of claim 3, wherein after the adding to display the switch component on the dashboard, the method further comprises:
in response to switching the permission information from the effective state to an invalid state, canceling displaying the switch component on the dashboard;
or
after the adding to display the switch component on the management page, the method further comprises:
in response to switching the permission information from the effective state to an invalid state, canceling displaying the switch component on the management page.

5. The method of claim 1, wherein after the displaying the switch component, the method further comprises:
in response to switching the permission information from the effective state to an invalid state, saving a state of the switch component and canceling displaying the switch component; and
in response to switching the permission information from the invalid state to the effective state, displaying the switch component according to the saved state.

6. The method of claim 1, wherein the method further comprises:
in response to simultaneously detecting a state switch request triggered for the switch component and a first request for requesting to switch the permission information from the effective state to an invalid state, executing the first request and displaying third prompt information, wherein the third prompt information is used to indicate that execution of the state switch request fails because the permission information is in the invalid state, and the state switch request is used to request to switch the switch component from an off state to an on state, or to switch the switch component from an on state to an off state.

7. The method of claim 1, wherein the method is applied to a second terminal, and the method further comprises:
in response to simultaneously detecting a state switch request triggered for the switch component and a second request for requesting to cancel a management permission of the second terminal for the data sheet, executing the second request and displaying fourth prompt information, wherein the fourth prompt information is used to indicate that execution of the state switch request fails because the second terminal does not have the management permission for the data sheet, and the state switch request is used to request to switch the switch component from an off state to an on state, or to switch the switch component from an on state to an off state.

8. The method of claim 6, wherein different requests are triggered by different terminals, and the state switch request is triggered by the second terminal.

9. The method of claim 1, wherein the data sheet is preconfigured with a plurality of first terminals; and
the method further comprises:
in response to a preview operation triggered for the dashboard, displaying a preview page, wherein the preview page displays, by default, a display effect of the dashboard on a third terminal, and the plurality of first terminals comprise the third terminal; and
in response to a preview object switch operation triggered for the preview page, updating the preview page, wherein the preview object switch operation is used to indicate switching from the third terminal to a fourth terminal, the plurality of first terminals comprise the fourth terminal, and the updated preview page is used to display a display effect of the dashboard on the fourth terminal.

10. A sheet data processing method, wherein the method is applied to a first terminal, and the method comprises:
displaying a dashboard, wherein the dashboard is determined according to a data sheet, the data sheet is preconfigured with permission information, and the permission information is used to indicate an access permission of the first terminal for data in the data sheet;
in response to a state switch operation triggered for a switch component on a second terminal, displaying a prompt page, wherein the prompt page is used to indicate that a data permission of the dashboard has changed; and
in response to a trigger operation for an update component in the prompt page, updating the dashboard, wherein the dashboard before the updating is not constrained by using the permission information, the state switch operation is used to indicate switching the switch component from an off state to an on state, and the updated dashboard is constrained by using the permission information, or the dashboard before the updating is constrained by using the permission information, the state switch operation is used to indicate switching the switch component from an on state to an off state, and the updated dashboard is not constrained by using the permission information.

11. The method of claim 10, wherein the dashboard comprises a plurality of components, and different components are used to display different data analysis results for the data sheet; and
when the dashboard is constrained by using the permission information, if the permission information indicates that the first terminal has no permission to access a first data set in the data sheet, and the first data set comprises any column or any row in the data sheet, for any component in the dashboard, a display process of the component comprises:
if key information for rendering the component comprises the first data set, using preset content to replace the component for display, wherein the key information is used to form the data analysis result displayed by the component, and the preset content is used to indicate that the first terminal has no permission to view the data analysis result displayed by the component; and
if the key information for rendering the component does not comprise the first data set, rendering the component according to the data sheet and displaying the component.

12. The method of claim 10, wherein the dashboard comprises a plurality of components, and different components are used to display different data analysis results for the data sheet; and
when the dashboard is constrained by using the permission information, if the permission information indicates that the first terminal has no permission to access some data in a second data set in the data sheet, and the second data set comprises any column or any row in the data sheet, for any component in the dashboard, a display process of the component comprises:
if key information for rendering the component comprises the second data set, rendering the component according to data other than the some data in the second data set and displaying the component, wherein the key information is used to form the data analysis result displayed by the component; and
if the key information for rendering the component does not comprise the second data set, but a rendering process of the component uses the second data set, rendering the component according to data other than the some data in the second data set and displaying the component.

13. An electronic device, wherein the device comprises a processor and a memory;
the memory is configured to store an instruction or a computer program; and
the processor is configured to execute the instruction or the computer program in the memory, to enable the electronic device to perform a sheet data processing method comprising:
displaying a dashboard, wherein the dashboard is configured to describe a data analysis result for a data sheet, the data sheet is preconfigured with permission information, and the permission information is used to indicate an access permission of a first terminal for data in the data sheet;
in response to the permission information being in an effective state, displaying a switch component, wherein the switch component is used to use the permission information to constrain the dashboard displayed in the first terminal; and
in response to the switch component being in an on state, displaying first prompt information, wherein the first prompt information is used to indicate that the permission information is used to constrain the dashboard displayed in the first terminal.

14. The electronic device of claim 13, wherein the method further comprises:
in response to the switch component being in an off state, displaying second prompt information, wherein the second prompt information is used to indicate that the permission information is not used to constrain the dashboard displayed in the first terminal.

15. The electronic device of claim 13, wherein a display process of the switch component comprises:
in response to the permission information being in the effective state, adding to display the switch component on the dashboard;
or
an entry identification of a management page is displayed on the dashboard, and a display process of the switch component comprises:
in response to a trigger operation for the entry identification, displaying the management page, and in response to the permission information being in the effective state, adding to display the switch component on the management page.

16. The electronic device of claim 15, wherein after the adding to display the switch component on the dashboard, the method further comprises:
in response to switching the permission information from the effective state to an invalid state, canceling displaying the switch component on the dashboard;
or
after the adding to display the switch component on the management page, the method further comprises:
in response to switching the permission information from the effective state to an invalid state, canceling displaying the switch component on the management page.

17. The electronic device of claim 13, wherein after the displaying the switch component, the method further comprises:
in response to switching the permission information from the effective state to an invalid state, saving a state of the switch component and canceling displaying the switch component; and
in response to switching the permission information from the invalid state to the effective state, displaying the switch component according to the saved state.

18. The electronic device of claim 13, wherein the method further comprises:
in response to simultaneously detecting a state switch request triggered for the switch component and a first request for requesting to switch the permission information from the effective state to an invalid state, executing the first request and displaying third prompt information, wherein the third prompt information is used to indicate that execution of the state switch request fails because the permission information is in the invalid state, and the state switch request is used to request to switch the switch component from an off state to an on state, or to switch the switch component from an on state to an off state.

19. The electronic device of claim 13, wherein the method is applied to a second terminal, and the method further comprises:
in response to simultaneously detecting a state switch request triggered for the switch component and a second request for requesting to cancel a management permission of the second terminal for the data sheet, executing the second request and displaying fourth prompt information, wherein the fourth prompt information is used to indicate that execution of the state switch request fails because the second terminal does not have the management permission for the data sheet, and the state switch request is used to request to switch the switch component from an off state to an on state, or to switch the switch component from an on state to an off state.

20. The electronic device of claim 18, wherein different requests are triggered by different terminals, and the state switch request is triggered by the second terminal.
